(19) United States
(12) Patent Application Publication
(10) Pub. No.: US 2011/0179420 A1
(43) Pub. Date: Jul. 21, 2011

(54) Computer System and Method of Operation Thereof

(75) Inventor: John Roe, London (GB)

(73) Assignee: NOKIA CORPORATION, Espoo (FI)

(21) Appl. No.: 12/521,750

(22) PCT Filed: Dec. 28, 2007
(86) PCT No.: PCT/GB2007/005024

§ 371 Date: Dec. 29, 2010

(30) Foreign Application Priority Data
Dec. 29, 2006 (GB) 0626026.9

(51) Int. Cl. G06F 9/46

(52) U.S. Cl. 718/102

(57) ABSTRACT

Within a computer system typically any server process will serve client requests to actually use the system resource to which the server process relates, e.g. a file server process will relate to the file system stored typically on a hard disk or the like and provide read/write access thereto, or to respond to a client request for information of one or more properties of the system resource. For example, a client may request a file server process to report back the amount of spare capacity in the file storage system. However, if no client processes are currently requesting actual use of the resource, then there will be no changes in the system resource which will require notification in any event. Therefore, in the case that all the client programs connected to the server are connected for notification services only, rather than access services, then the server will not in fact be used, and moreover no changes to the system resource will need to be notified (because there has been no use of the resource to cause any changes). In this case, therefore, the access server can be unloaded from main or higher memory, thus providing savings in memory and CPU execution cycles.

### TECHNICAL FIELD

The present invention relates to a computer system and method of operation thereof, and in particular to a computer system and method of operation where an administration program which provides for access and/or control of a system resource is loaded into main or higher memory only when it is required, and not loaded otherwise. The decision as to whether the administration program is loaded is made in dependence on the type of usage requested of said program by client programs.

### BACKGROUND TO THE INVENTION AND PRIOR ART

Computer systems are well known in the art. FIG. 1 illustrates a typical simplified computer system architecture for computer system 10 known in the art. More particularly, the computer system 10 comprises a central processing unit 102, which is arranged to communicate via a bus 103 with a memory, and various input and output devices, as well as other system resources, such as memory resources, and communications resources. More particularly, a memory 104 is provided, which would typically be random access memory (RAM), and which stores various programs to allow the computer system 10 to operate. In particular, as shown, the memory 104 may store a video driver program 1042, which allows the computer system operating system (not shown) to communicate with a video controller 106, which controls an output video screen 114. A keyboard driver 1044 is also stored in the memory 104, which allows the computer system operating system to communicate with a keyboard controller 108, which controls a keyboard 116. Similarly, a hard disk driver 1046 is stored in the memory 104, which allows the operating system to communicate with a hard disk controller 110, which controls a hard disk 118. Likewise, a network driver 1048 is also stored in the memory 104, which allows the operating system to communicate with a network interface controller 112, which controls a network card 120 to allow the computer system 10 to communicate with other computer systems via a network 122. In order to allow the computer system to operate, as shown the various device drivers must be stored in the memory 104, to allow user processes to access or control the various system resources, as well as to obtain information as to one or more properties of the various system resources, such as, for example, hard disk capacity, network connection speed, video screen resolution, or the like. The device drivers 1042 to 1048 must therefore contain code to allow for access and/or control of the respective system resources, as well as to provide notification of one or more properties of the system resources to other requesting processes running on the computer system.

In terms of a typical operating system structure for use with a computer system, such as the computer system 10, it is known to try and remove as much code as possible up into higher layers away from the operating system kernel, leaving a minimal “microkernel”. Most of the operating system can then be implemented in user processes, rather than in kernel mode. To request a service, such as reading a block of a file, a user process, known as a client process, sends a request to a server process, which then does the work, and sends back the answer. FIG. 2 illustrates a typical client server operating system structure 20. Here, the “microkernel” 202, being those parts of the operating system operating in kernel mode, routes client requests 216 from a requesting client process 206 to the appropriate server process, in this case a file server 212. Client processes 204 and 206, and server processes 208, 210, 212 and 214 therefore sit in user mode above the microkernel, with client request messages and server response messages being routed between processes by the microkernel. Splitting the operating system up into parts means that each part becomes smaller and more manageable, and moreover, a degree of separation is maintained between the different server processes, such that a bug in one server process may not necessarily bring the whole machine down.

A further advantage of the client-server model is its ability to be used with distributed systems comprising multiple machines. FIG. 3 illustrates such an arrangement, wherein a distributed system 30 comprises separate machines 312, 314, 316 and 318, which are arranged to communicate with each other by virtue of a network 302. Each machine is provided with its own operating system kernel, and either runs a client process 304, or a server process 306, 308 or 310, in user mode on top of the kernel. Client requests 320 can then be handled by the respective kernels and transmitted via the network 302, such that as far as the client processes and the server processes are concerned, it makes no difference as to whether the request and response messages are transmitted by the kernel on the same machine, or across a network.

Whether the system is distributed across several machines, or located on the same machine, from boot up in a typical operating system there will be a great many server processes running, consuming resources as they go. However, often much of the implementation of a server is lying idle in RAM, as client programs are not using the system resource to which the server relates, but are instead merely interested in being notified of any changes in the system resource. Such idle servers therefore consume main memory, or higher memory, needlessly. It would therefore be beneficial to address this problem, in order to reduce memory usage by idle servers.

Additionally, the same problem arises when considering device drivers such as, for example, described previously in respect of FIG. 1, even when a client server operating system architecture is not used. In particular, much of the driver implementation is concerned with being able to communicate with the device controller to allow use of the device i.e. read or write access, for example. However, for the same reasons as discussed above in respect of a client server architecture, much of the time only notification services are being provided, rather than actual use of the system resource. This in turn means that memory is being wasted storing that part of the implementation of the device drivers which relates to the ability to actually use the system resource to which the driver relates, rather than simply notifying properties of the system resource.

### SUMMARY OF THE INVENTION

Within embodiments of the invention the above problem is addressed using the inventor's realisation that the tasks that a server or device driver typically performs in response to client requests can be generalised as follows:—

a) providing access (e.g. read or write) to a system resource; and
b) providing notification services for changes in the system resource.

That is, typically any server process will serve client requests to actually use the system resource to which the server process relates, e.g. a file server process will relate to the file system stored typically on a hard disk or the like and provide read/write access thereto, or to respond to a client request for information of one or more properties of the system resource. For example, a client may request a file server process to report back the amount of spare capacity in the file storage system. However, the inventor has realised that if no client processes are currently requesting actual use of the resource, then there will be no changes in the system resource which will require notification in any event. Therefore, in the case that all the client programs connected to the server are connected for notification services only, rather than access services, then the server will not in fact be used, and moreover no changes to the system resource will need to be notified (because there has been no use of the resource to cause any changes). In this case, therefore, the access server can be unloaded from main or higher memory if it is already loaded, or not loaded otherwise. In view of the above, within embodiments of the invention the individual purposes of the client programs' connections to an access server are determined, for example by definition of a connection type as being an access type or a notification type by a client side library, and then a decision is taken to unload the access server in dependence on the determined purposes. In particular, when all of the present client connections to a server are determined to be for notification purposes only, the access server can be unloaded from RAM. When a client then subsequently connects for access to the system resource, the server can be re-loaded to service the access request. In preferred embodiments, the server functionality can further be split to allow for a separate notifications server to be provided to service notification requests.

In view of the above, from a first aspect there is provided a computer system having at least one system resource, and provided with at least one system resource administrator program associated with said at least one system resource for administering said resource, the system having a control element which causes said system resource administrator program to be loaded into at least main or higher memory in dependence on the type of usage requests therefor made by other processes, said usage requests being one of a first type relating to requesting notifications of one or more properties of the system resource or a second type relating to requesting administration of said system resource.

By looking at the types of usage requests made to the system resource administrator, and categorising the usage requests into notification requests or administration requests, then a decision can be made as to whether the system resource administrator program can be loaded into main or higher memory, thus saving memory and execution cycles. In this way, the overall operation of the computer system can be improved.

Preferably, the system resource administrator program is unloaded from said main or higher memory (if loaded), or not loaded when said usage requests are each of the first type. When all of the usage requests are notification requests, then no changes will occur to the system resource which need notifying, and hence there is no need, in this first case, for the system resource administrator program to be kept running. Conversely, preferably said system resource administrator program is loaded into main or higher memory when at least a subset of said usage requests are of the second type. In this case, the administrator program is required to serve a client request, and hence should be loaded.

From another aspect there is also provided a computer system having a notification management program which determines whether a request made by another process to use a system resource is of a first type relating to requesting notifications of one or more properties of the system resource, or of a second type relating to requesting administration of said system resource, wherein when said other process request is of the first type, an identifier corresponding to said other process and the request type is stored.

In this way, a list of requesting processes which have requested notification services can be maintained by the notification management program. This facilitates the operation of the invention according to the first aspect, as it means a system administrator program does not need to be maintained in memory to maintain the list of notification requesting programs.

From a further aspect there is also provided a computer system having a system resource request labelling element arranged to receive requests for usage of a system resource, and determine the type of the request as one of a first type relating to requesting notifications of one or more properties of the system resource, or of a second type relating to requesting administration of said system resource, the labelling element being further arranged to label said requests as one of said first or second types.

Such a system insulates requesting programs from the need to label requests as one of the first type or the second type, which labels are useful to facilitate the inventions of the first or second aspects above. The ability to insulate requesting programs from the requirement to classify their usage requests as such allows embodiments of the invention to be used with legacy programs.

Further aspects, features, and advantages of the invention will be apparent from the appended claims.

### BRIEF DESCRIPTION OF THE DRAWINGS

Further features and advantages of the present invention will also become apparent from the following description of embodiments thereof, presented by way of example only, and by reference to the accompanying drawings, wherein like reference numerals refer to like parts, and wherein:—

FIG. 1 is a block diagram of a computer system of the prior art;

FIG. 2 is a diagram of a client server operating system structure of the prior art;

FIG. 3 is a diagram of a client server operating system structure of the prior art;

FIG. 4 is a diagram of an operating system structure according to a first embodiment of the present invention;

FIG. 5 is a diagram of the operating system structure according to the first embodiment of the present invention;

FIG. 6 is a flow diagram illustrating processing steps involved in the first embodiment of the present invention;

FIG. 7 is a diagram illustrating an operating system structure according to a second embodiment of the present invention;

FIG. 8 is a diagram of the operating system structure according to the second embodiment of the present invention;

FIG. 9 is a flow diagram illustrating processing steps involved within the second embodiment of the present invention;

FIG. 10 is a diagram illustrating an operating system structure according to a third embodiment of the present invention;

FIG. 11 is a diagram illustrating the operating system structure according to the third embodiment of the present invention;

FIG. 12 is a diagram illustrating an operating system structure according to a fourth embodiment of the present invention;

FIG. 13 is a diagram illustrating the operating system structure according to the fourth embodiment of the present invention;

FIG. 14 is a diagram illustrating a fifth embodiment of the present invention;

FIG. 15 is a diagram illustrating a sixth embodiment of the present invention;

FIG. 16 is a flow diagram illustrating steps performed in any of the fifth or sixth embodiments of the present invention;

FIG. 17 is a flow diagram of the steps performed in a seventh embodiment of the present invention; and

FIG. 18 is a diagram illustrating a seventh embodiment of the present invention.

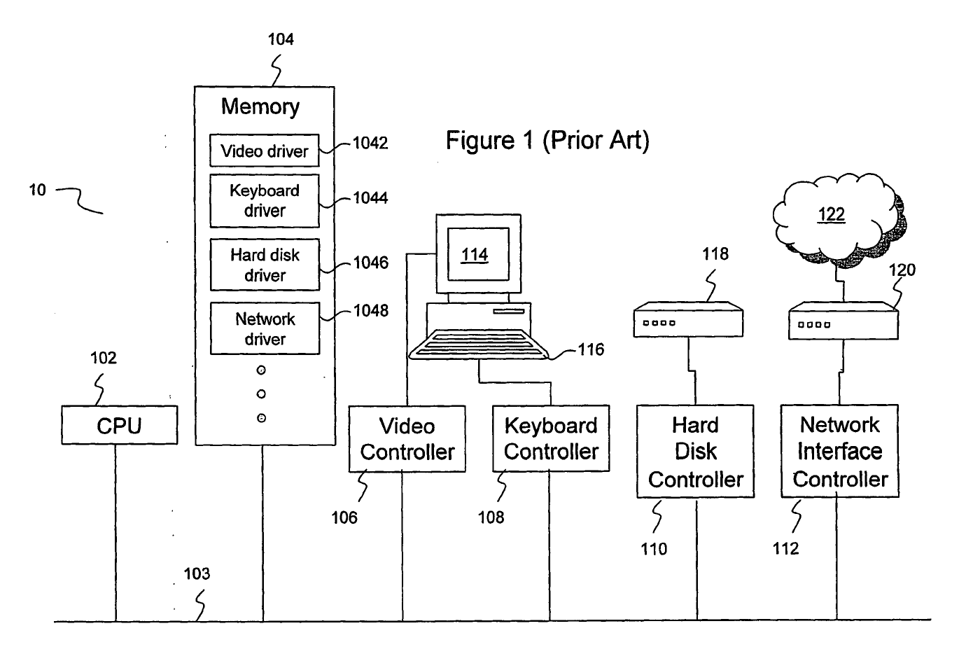

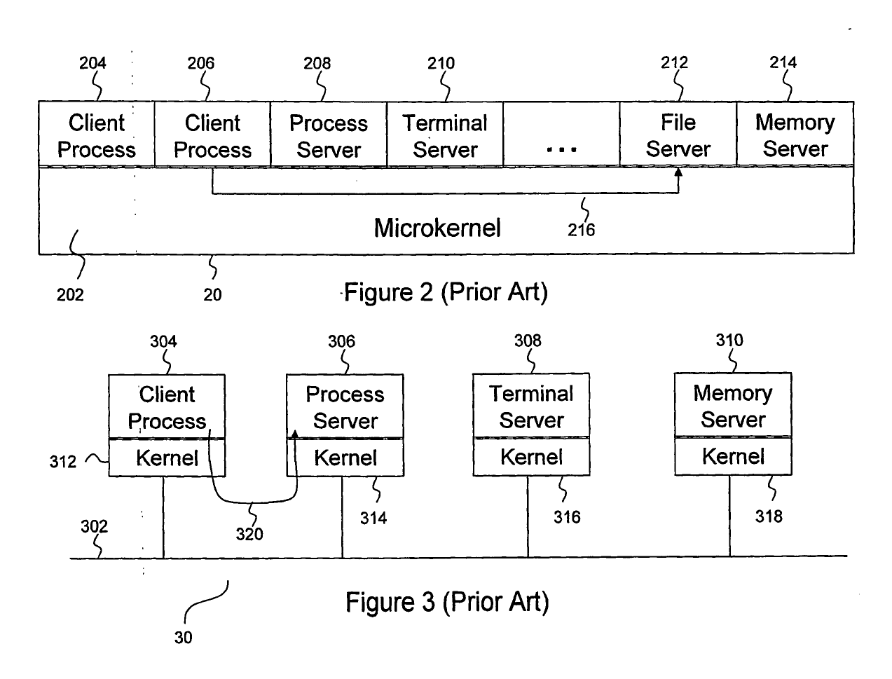

### DESCRIPTION OF THE EMBODIMENTS

A number of embodiments of the present invention will now be described with respect to the accompanying drawings.

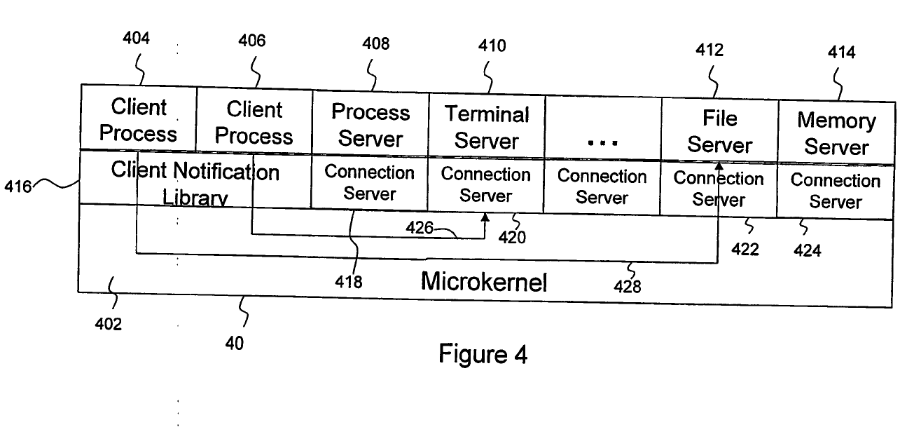

More particularly, FIG. 4 illustrates an operating system structure 40 according to a first embodiment of the present invention, which operating system structure may run on a computer system, such as the computer system 10 described previously. The operating system 40 is in the form of a client server architecture, with the operating system kernel 402 providing message routing functions between client processes, and server processes. More particularly, as shown client processes 404 and 406 are provided, as well as server processes 408, 410, 412 and 414. Additionally provided associated with each server process is a connection server 418, 420, 422 and 424. At the client side, a client notification library 416 is provided. The functions and responsibilities of the server processes 408, 410, 412 and 414, as well as the connection server processes 418, 420, 422 and 424, and the client notification library 416 will be described below.

Within the embodiments to be described below we refer to server processes which provide access to or control of a system resource as “access servers”. However, it should be noted that the servers may provide more than mere access to the system resource, and may further provide some degree of control of the system resource. Whether a system resource requires “access” and/or “control” will depend on the particular nature of any particular system resource. Collectively, we refer to the ability of a server process to provide access to and/or control of a system resource as being able to administer the resource. Therefore, a server process for a system resource can be thought of as a system resource administration program.

More particularly, within embodiments of the present invention to be described we address the above noted problems by providing for the purpose of a client connection to a server program to be determined, and then a decision on whether a server program can be unloaded (if loaded) or not loaded (if not already loaded) being taken in dependence on the determined client connection request purpose. In particular, when it is determined that all of the clients connected to an access server are merely connected for notifications, then the access server program can be unloaded from (or not loaded into, if not already loaded) main or higher memory. The access server program can then be reloaded when an access request is received.

Within this specification, in order to avoid having to refer to the access server being both unloaded from memory, if already loaded, or not loaded, if not already loaded, we use the term “unloaded” to cover both eventualities i.e. the access server being “unloaded” means that it does not reside in main or higher memory after being unloaded, whether or not it resided in main or higher memory previously. Conversely, and following the same principle, by the term “loaded” we mean that the access server is loaded into main or higher memory if it is not already resident in main or higher memory, or maintained in main or higher memory if it is already resident in main or higher memory.

Moreover, in the case that an access server did previously reside in main or higher memory prior to being unloaded, the act of unloading the access server from main or higher memory does not necessarily mean that the actual memory registers which held the server are reset to any particular value, although in some embodiment this may be the case. In other embodiments however, once a server has been unloaded the memory registers which previously held the server may simply be made available once again to the memory manager to be overwritten with other data, as is well known in the art.

In order to be able to determine the purpose of the client connections, within preferred embodiments of the invention several connection types are defined, and in particular at least an access connection type, and a notification connection type. In preferred embodiments a client side library preferably insulates the client programs from the need to define connection types, thus allowing legacy client programs still to be used, but labels connection requests with the connection type, for example by examination of the calling function of the client program which generated the connection request. In this respect, a priori knowledge of the structure and operation of the client program allows the client notification library to determine whether a server connection request is an access request or a notification request dependent on what exactly the client program is presently doing. In other embodiments the client programs themselves can be adapted to label their connection requests with the connection type.

In terms of the various connection types, at least an access type and a notification type are defined. However, the access type can be further broken down, for example to specify a read access type and a write access type. With such connection types defined, however, at the server side a connection server is provided associated with the access server to which the connection request is first routed. The connection server examines the connection type of a connection request, and if it is an access request passes the connection to the access server. If the access server is not presently loaded, the connection server causes the access server to be loaded to serve the access request.

Conversely, however, if the connection request is of the notification type, then there is no need for the access server to be loaded, and a notification connection is established between the requesting client and the connection server. In this respect, the connection server in one embodiment is an extremely lightweight server, whose only functionality is to maintain a list of client connections and their types, and to call the access server when an access connection request is received from a client, and to cause the access server to be shut down when the connection list indicates that all the connections are of the notification type. By “lightweight”, we mean that the server consumes very little memory, and requires few execution cycles to perform. In this respect, “lightweight” is a relative term, with a “lightweight” process requiring fewer system resources to operate than a “heavyweight” process. In the context of the present embodiments, the connection server is much more lightweight than the more heavyweight access server to which it is associated.

The connection server then maintains the notification connections to the various client programs connected for notifications. However, because no clients are connected for access, there will be no changes to the system resource which need notifying. Therefore, the connection server can be thought of as an extremely lightweight proxy for the access server, which is provided to meet the needs of client programs which require notification connections, but which will take up much less main or higher memory than the fully functional access server. Using such a proxy connection server in place of the access server therefore allows client connections to be tracked, and for the access server to be loaded when required, but allows the fully functional access server to be generally unloaded from memory, thus providing memory savings, which are useful in any system.

Returning to FIG. 4, therefore, each of the server processes 408, 410, 412 and 414 is respectively arranged to allow for use of the system resource to which it relates, but to be unloaded when no system resource usage or access requested is received. To maintain the list of client connections, however, the connection servers 418, 420, 422 and 424, are respectively provided which first receive client connection requests and examine the connection types. If a connection is determined to be an access type, then it is passed to the access server which is loaded into main or higher memory. If, however, it is determined to be a mere change notification request, then the client is added to the list maintained by the connection server of clients connected for notifications.

At the client side, in order to insulate the client processes 404 and 406 from the split of functionality between the server processes and the connections servers, the client notification library 416 acts to process client requests to determine whether they are notification requests, or system resource usage requests e.g. read or write requests, and the like. If a request is identified as a notification request, such as request message 426 in FIG. 4, then it is routed to the appropriate connection server for the system resource in respect of which notification is requested. Similarly, if a client request is identified as a system resource usage request, such as request message 428 in FIG. 4, then it is routed to the particular server process which permits control or access to the requested system resource, via the connection server for that process.

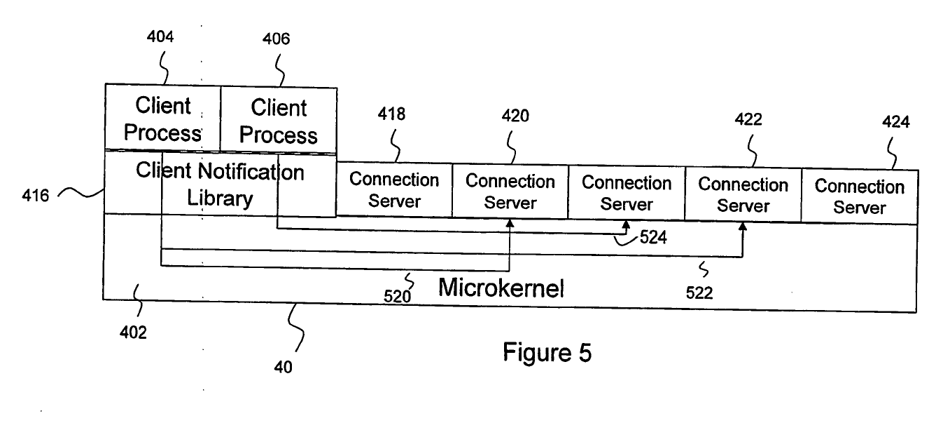

The advantage of such an arrangement is shown in FIG. 5. Here, given that the client processes 404 and 406 are connected merely for notification purposes only (in this case, for example, for notification of changes in the file system, amongst others), then the various server processes can be unloaded from memory, leaving only the connection servers running to maintain the list of clients connected for notification purposes. As the connection servers are considerably more lightweight than the server processes, then much memory can be saved by such a technique.

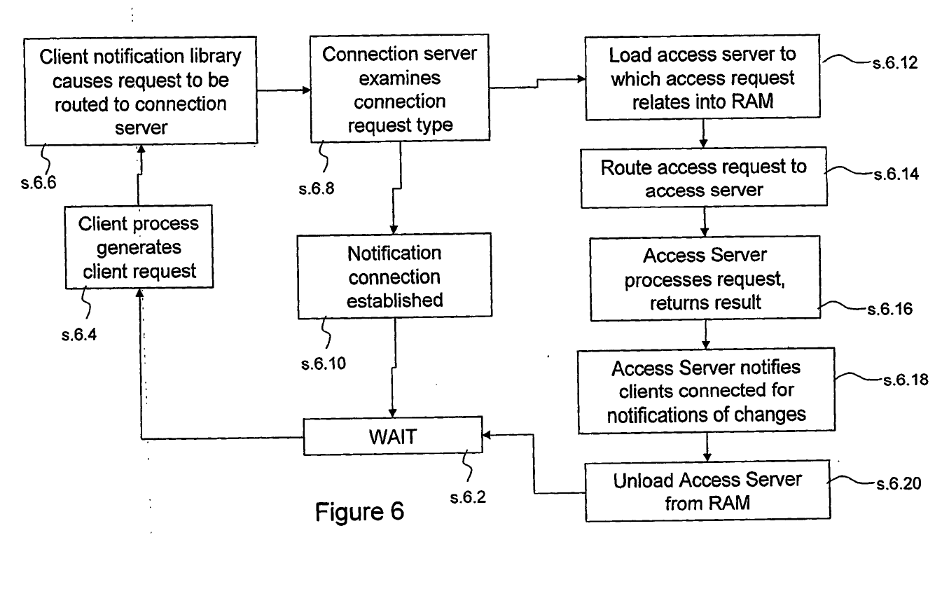

FIG. 6 illustrates the steps performed by the various elements described above within the first embodiment of the invention.

Assuming that the operating system is in a wait state at step 6.2, and that at least one client process is running, at step 6.4 the client process may generate a client request, to be routed by the kernel to a server process, or the connection server, as appropriate. At step 6.6 the client notification library is used to determine the connection request type i.e. notification or access, and to label the connection request with the type, if required. The client notification library also changes the routing information of the request to cause the kernel to route the request to the appropriate connection server for the access server process of interest. These operations of the client notification library help to insulate the client process from the need to know about the connections servers, thus allowing legacy client programs to be used with the embodiments of the invention.

At step 6.8 the operating system kernel routes the connection requests to the appropriate connection server responsible for the system resource in respect of which connection has been requested, and the connection server examines the type of the connection request to determine if it is a notification request or an access request. If the type indicates a notification request then processing proceeds to step 6.10. At step 6.10 the connection server processes the request, adds the client to the list of clients connected for notifications, and if necessary the operating system returns a result message back to the requesting client process to indicate that the notification connection is established. Following step 6.10, the procedure then enters the wait state of step 6.2.

If at step 6.8 a determination was made that the client request was an access or usage request, then at step 6.12 the connection server causes the operating system to load the server process to which the access request relates into RAM. Elements of the process may be loaded into higher layer memory in the computer system memory hierarchy, if necessary. At step 6.14 the operating system routes the client request to the server process, then at step 6.16 the server process processes the request and operates the system resource to which it relates, in accordance with the request. Any result returned from the operation is then returned.

Because there has been some usage of the system resource to which the server process relates, then it is possible that some changes will have occurred to the system resource. For example, if the system resource is a hard disk and the usage of the system resource was to write some data to the hard disk, then there may well be a change in the disk spare capacity. In order to keep the clients which are connected for notifications aware of the change, in the present embodiment, at step 6.18 the server process communicates with its associates connections server to access the list of clients connected for notifications, and then notifies the clients in the list of any change in the system resource. In this respect, the access server is provided with notification functionality to allow it to compile and send a suitable notification message to the connected clients. Once this notification has occurred, then the server process can be unloaded from RAM, and this occurs at step 6.20. The procedure then returns to the wait state of step 6.2, pending further client requests.

Thus, within the first embodiment by splitting up the functionality of the server processes into a first part which is required to actually access, control, or otherwise use the system resource to which it relates, and a second part which simply maintains a list of clients connected for notifications, a more efficient use of memory can be obtained.

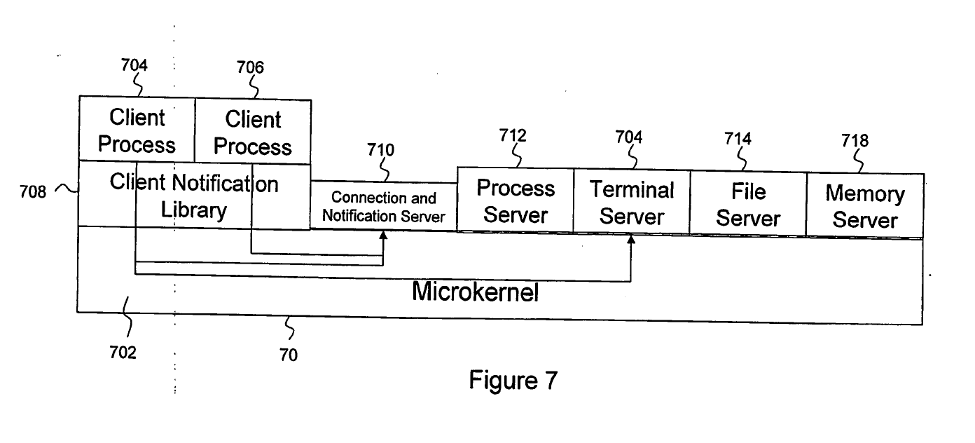

A second embodiment of the present invention will now be described with respect to FIGS. 7 to 9.

According to a second embodiment of the invention, an operating system 70 comprises an operating system kernel 702, which is shown in FIG. 7 to be a microkernel. The operating system is in the form of a client server architecture, as described previously, and is provided with client processes 704 and 706, and server processes 712, 714, 716 and 718. Additionally provided is a client notification library 708, and a single connection and notification server 710.

Within the second embodiment, unlike in the first embodiment where a separate connection server was provided for every server process, within the second embodiment a single connection and notification server 710 is provided, which acts as a connection server for several or all of the server processes running on the system, and in addition also includes notification functionality to allow it to notify client programs of any changes in the system resources with which it is associated. The client notification library 708 is updated to take this into account, and in addition to labelling client connection requests with the connection type, if required, also acts to cause the requests to be routed to the connection and notification server 710, which, in the case of an access request, can then reroute the connection to the actual access server required. Messages 720 and 722 illustrate both of these forms of operation.

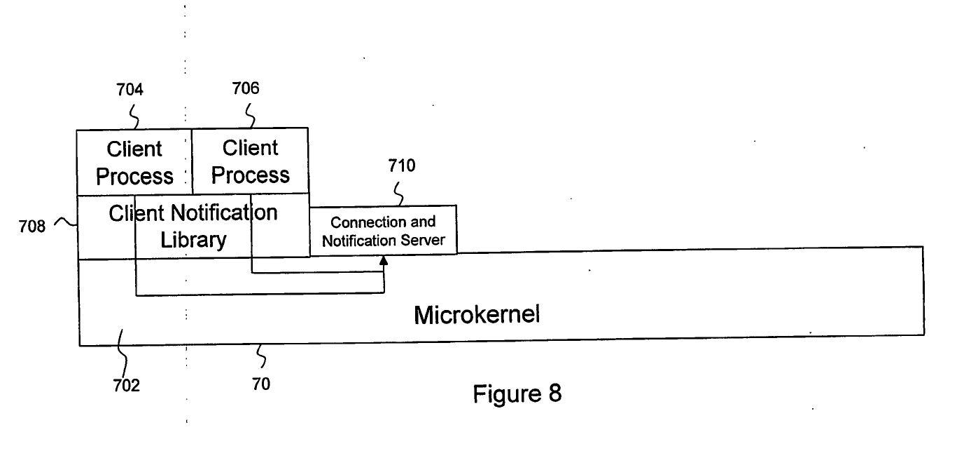

Within the second embodiment, even more memory is saved than in the first embodiment, as it is necessary only to have a single connection and notification server 710, which then acts as the connection server for each of the other server processes running on the system, and in addition provides centralised notification services to notify changes in the system resources with which it is associated to the clients connected for notifications. Thus, as shown in FIG. 8, when the only clients present are those which require notification services relating to one or more properties of the system resource or resources, then it is possible to unload all of the other server processes from memory, thus giving the memory saving which is obtained. Moreover, because the notification functionality is also included in the connection and notification server 710, then the access servers themselves can be more lightweight, as they do not need to contain such functionality. This is of particular help where it is necessary to have multiple access servers running at once, as if each contained its own notification functionality then more memory would be used storing the servers than is used by having the centralised notification functionality in the connection and notification server 710.

With respect to the connection and notification server 710, of necessity it is not as lightweight as the individual connection servers of the first embodiment, each of which only dealt with a single system resource. In particular, the connection and notification server 710 of the second embodiment must be able to store information relating to the state, and/or one or more properties of each of the system resources for which it is acting as notification server. However, the advantages of instruction re-use in the actual notification process would typically mean that the single connection and notification server 710 which acts for a plurality, or all of the server processes, would likely still be of a smaller size than the sum of the individual connection servers of the first embodiment.

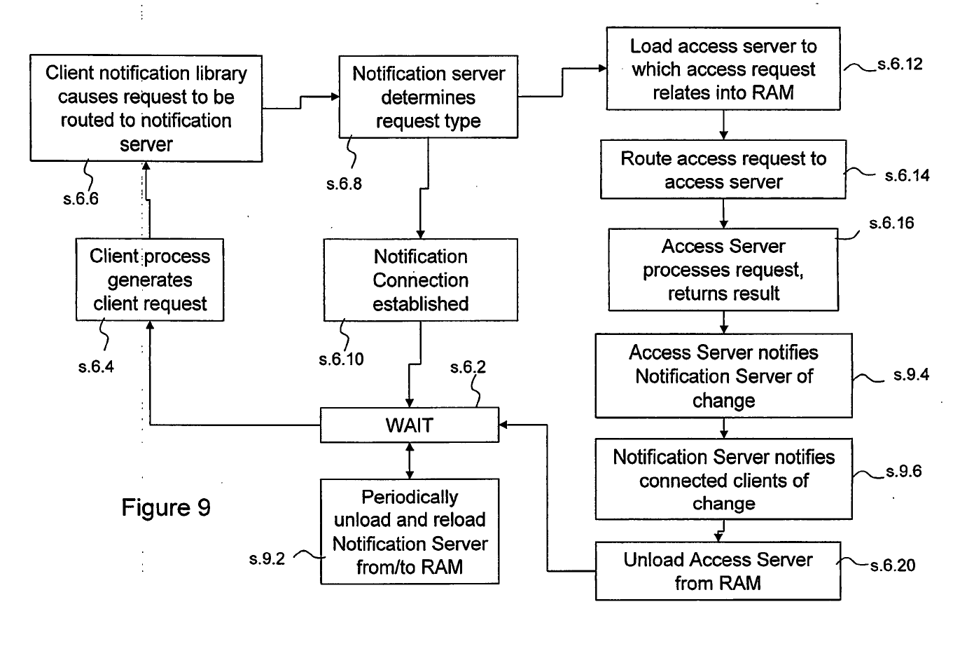

FIG. 9 illustrates the steps performed in operating the second embodiment of the present invention, and in particular includes steps 6.2 to 6.16, and step 6.20, which are identical to those described previously in respect of FIG. 6 in the first embodiment, although with the following minor changes. More particularly, at step 6.8 and 6.10, it is the single connection and notification server 710 to which notification requests are routed, and which processes the request.

Different from the first embodiment, however, at step 9.4 once a server process has served a client request to access, control, or otherwise use the system resource, where a change has been made to that resource the server process must notify the single connection and notification server 710. Then, at step 9.6 the connection and notification server 710 notifies the clients it has connected thereto for notification of changes in the system resource of the change.

Additionally, within the second embodiment the single connection and notification server can be made to be deliberately transient, in order to reduce heap fragmentation. This is achieved by regularly restarting the connection and notification server, preferably when the clients are all in a suitable idle state. This is illustrated in FIG. 9 by step 9.2, wherein the notification server is periodically unloaded, and reloaded, from and to the main memory.

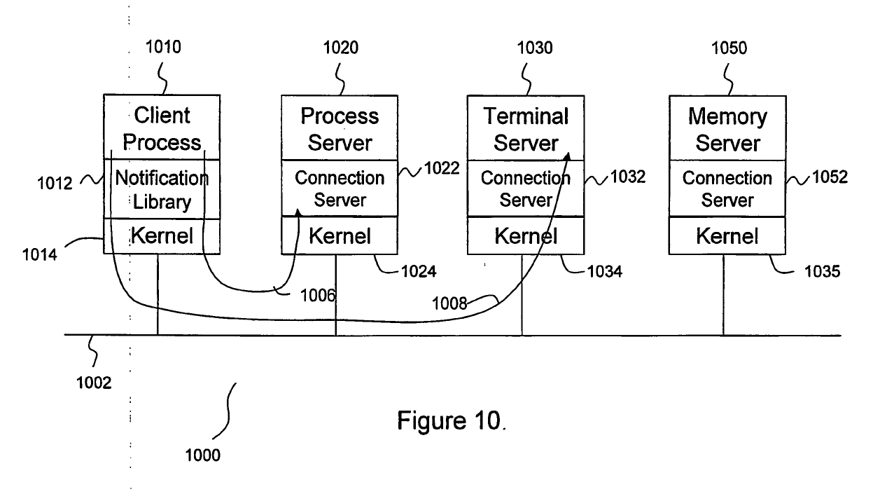

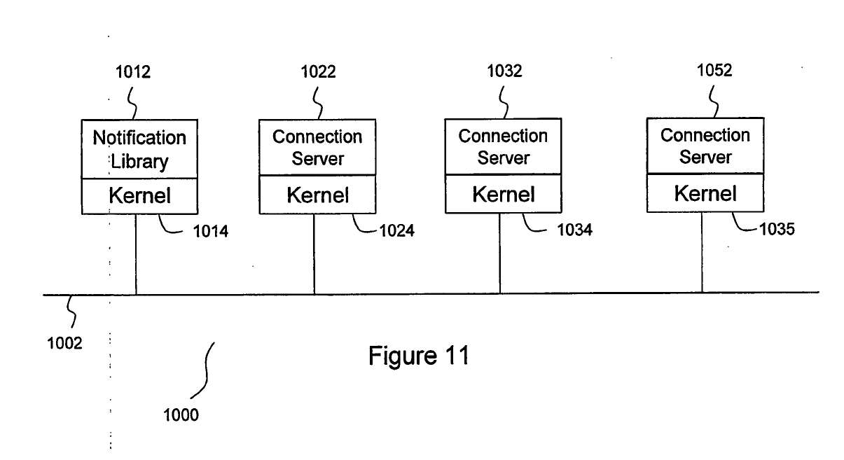

A third embodiment of the present invention will now be described with respect to FIGS. 10 and 11. Within the third embodiment the invention is used in a distributed environment wherein a plurality of machines, each provided with their own operating systems, communicate with each other via a network. Thus, the distributed computer system 1000 is provided comprising network 1002, and a plurality of machines connected to the network, and arranged to communicate between themselves via the network. Each machine is provided with an operating system kernel 1014, 1024, 1034 and 1035 respectively.

As described previously in respect of the first embodiment, within the third embodiment connection server processes are provided which maintain a list of client connections and there types, which list can be used to determine whether an access server can be unloaded, and in particular when all of the connected clients are connected for notifications only. Thus, as shown in FIG. 10, a first process server 1020 is provided with a corresponding connection server 1022, a terminal server 1030 is also provided with a corresponding connection server 1032, and the memory server 1050 is provided with a corresponding connection server 1052. At the client side, a client process 1010, so as to be insulated from this split in the server processes and the connection servers, has installed on the machine on which the client process 1010 is running a notification library 1012, which insulates the client process from the server split.

With the above arrangement, the operation is identical to that described previously in respect of the first embodiment, but taking into account that the various processes are running on different machines which are interconnected by a network 1002. However, when the client process 1010 requires notification of one or more properties of the system resource, then its request for this information is routed via the notification library 1012 to the appropriate connection server for that resource. An example of such a message is shown as message 1006. Likewise, when a client process requires to actually use a system resource i.e. to read or write data from or to the resource, then a request to use such a resource is routed via the notification library 1012 and the operating system kernel 1014 to the appropriate connection server, where the connection type is determined as an access type, and then passed to the appropriate access server process. An example of such a usage request message is shown as 1008.

When there are no client processes connected to use system resources, then the server processes can be unloaded from RAM, leaving the connection servers running. This is shown in FIG. 11. Such an approach again, as in the first embodiment, means that memory can be saved, by not having the heavyweight control/access server processes running when they are not required.

As mentioned, apart from the difference that the system 1000 is a distributed system, the operation of the third embodiment is otherwise identical to that of the first embodiment, and hence can be summarised by FIG. 6, described previously.

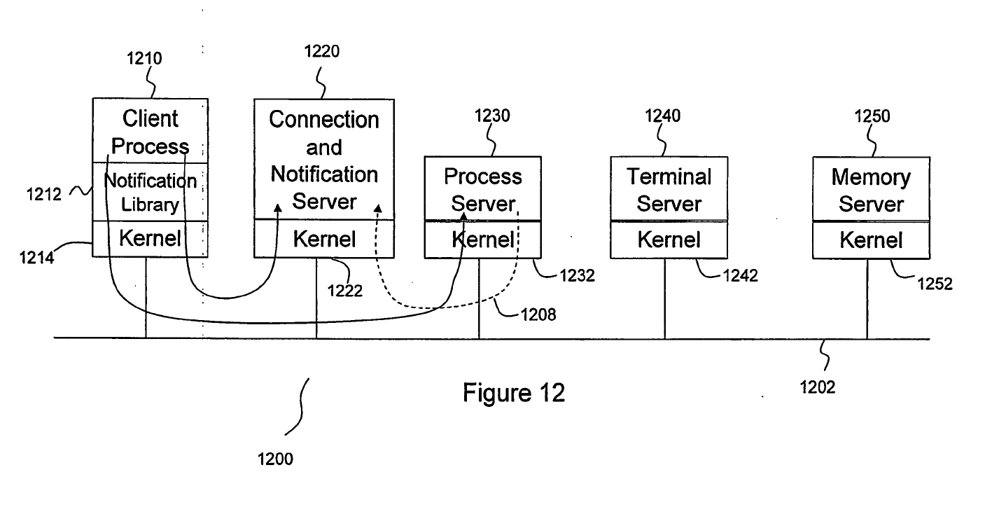

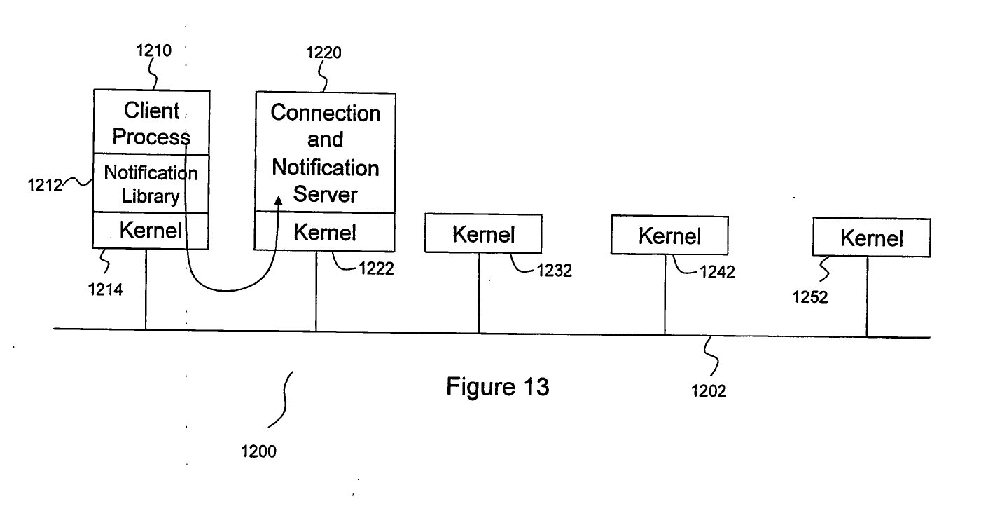

A fourth embodiment will now be described with respect to FIGS. 12 and 13. Within FIG. 12 a distributed system 1200 is shown, comprising a plurality of machines, each provided with their own operating system kernel 1214, 1222, 1232, 1242 and 1252 and each of which are arranged to intercommunicate via a network 1202. Within the fourth embodiment, as opposed to the third embodiment described previously, instead of there being provided a connection server for every server process, a single connection and notification server 1220 is provided which is arranged to maintain the client connection list and also to receive system resource change notifications from each of the server processes, and to store information relating to one or more properties of the system resource, and/or the state of the resource. A client process 1210 which desires to know one or more properties of the system resource formulates a notification request, which is labelled as a notification type and routed via a notification library 1212, and the operating system kernel 1214 of the machine on which the client process is running, to the connection and notification server 1220. The notification server can then answer the client request, by providing the appropriate information, and also adds the client to the list of clients for which notification connections are maintained. A separate client notification connection list is preferably maintained for each of the different access servers for which the connection and notification server 1220 acts.

Likewise, when a client process 1210 wishes to actually access or use a system resource then its request so to do is labelled and routed via the notification library 1212 to the connection and notification server, and from there, having been determined that it is an access request, on to the actual server process related to the resource.

When a server process has accessed, controlled, or otherwise used a system resource, and changes have been made to that resource, then as shown by message 1208 the server process must notify any changes in one or more properties of the system resource to the connection and notification server 1220, so that the notification server is up to date.

As in the previously described embodiments, and as shown in FIG. 13, when there is no pending request for a server process to access, control, or otherwise use a system resource, then that server process may be unloaded from the computer system main memory. However, the connection and notification server 1220 remains loaded, in order to serve notification requests, and to keep track of the client processes. However, the ability to unload the rest of the server processes saves on memory requirements.

In terms of the steps of operation of the fourth embodiment, the steps described previously with respect to FIG. 9 apply equally here, with the difference, of course, that being a distributed system the messages are routed via the operating system kernels and the network 1202, rather than within the operating system kernel of a single machine.

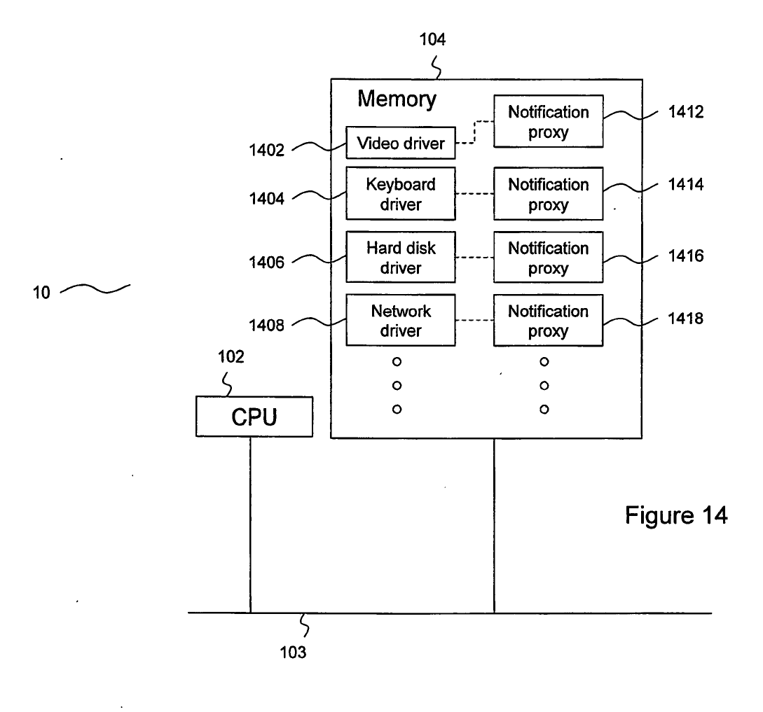

A fifth embodiment of the present invention will now be described with respect to FIG. 14.

The previously described embodiments all relate to client server type architectures of operating systems. However, the inventive concept of the present invention may also be applied in other contexts, such as, for example, when considering input/output (I/O) devices, and their associated hardware controllers, and software device drivers. As was described previously, a typical prior art computer system 10 is provided with several I/O devices, each having a controller, and an associated software device driver, which must be stored in memory.

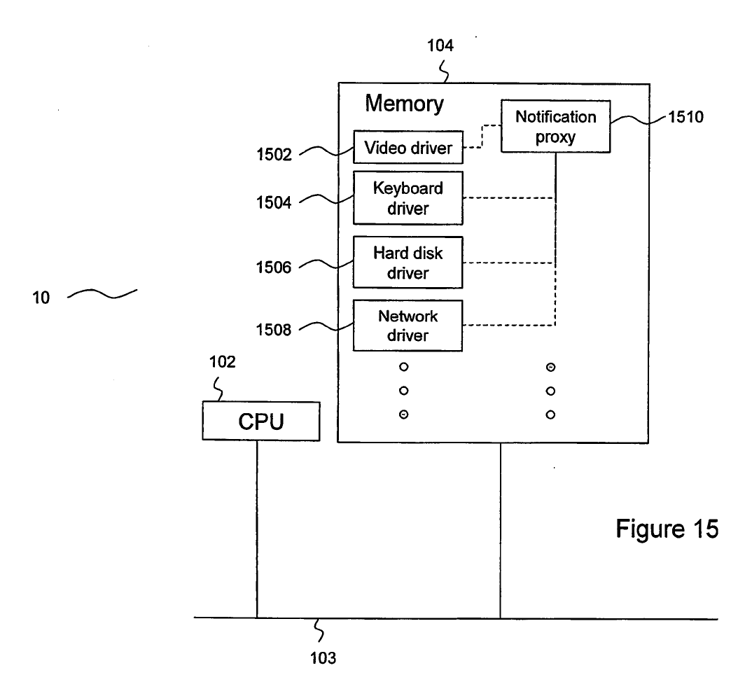

Applying the concepts of the present invention to such a situation, however, as shown in FIG. 14 it is possible to provide, for each driver, a notification proxy which merely deals with information requests as to the state of the device. The main driver, which contains the code necessary for handling the device hardware controller, can then be unloaded from memory, when the device is not in use. The corresponding notification proxy for the device is retained in memory, however, in order to report on the state of the device. As shown in FIG. 14, a corresponding notification proxy may be provided for each individual device driver, although in a further embodiment, as shown in FIG. 15, a single notification proxy 1510 may be provided, which handles notification requests relating to all of the I/O devices.

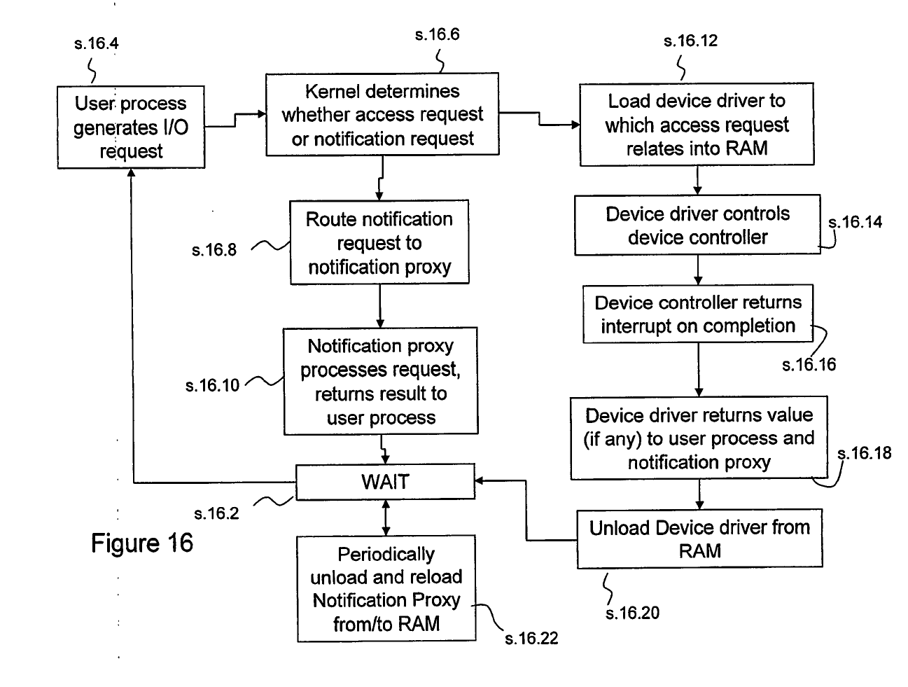

FIG. 16 is a flow diagram illustrating the operation of either of the embodiments of FIG. 14 or 15.

Assume the system is in the wait state step 16.2. When a user process generates an I/O request at step 16.4, the operating system kernel then determines the type of the request i.e. whether the request is an access request to use or access the device, or a notification request, at step 16.6. If the request is a notification request, to be notified of the state of one of the I/O devices, then at step 16.8 the operating system causes the corresponding notification proxy program for the device to be run, such that at step 16.10 the notification proxy program can process the user process request, and return any necessary result. Additionally, the notification proxy can, in some embodiments, maintain a list of user processes which have requested notifications, for future change notification Once the result has been returned the system re-enters the wait state at step 16.2.

On the other hand, if at step 16.6 the operating system had determined that the user process had made an access, control, or other usage request for one of the I/O devices, then at step 16.12 it causes the appropriate device driver for the requested device to be loaded into the memory 104. The loaded device driver then controls the relevant device controller for the device, and the device is operated by the controller in a conventional manner, to process the request. On completion, the device controller returns an interrupt, at step 16.16, and at step 16.18 returns the necessary value (if any) to the user process, and also notifies the appropriate notification proxy of any change to the device. Having performed these tasks, and provided that there are no further access requests pending, the device driver is then unloaded from RAM, at step 16.20. The system then re-enters the wait state of step 16.2. Note that the above noted operation relates to both of the embodiments of FIG. 14 or 15, the differences between the embodiments being simply that the embodiment of FIG. 15 has a single notification proxy which handles all of the I/O devices. Where a single notification proxy is used, to reduce heap fragmentation the notification proxy can be periodically unloaded and reloaded from and to the memory, as shown at step 16.22.

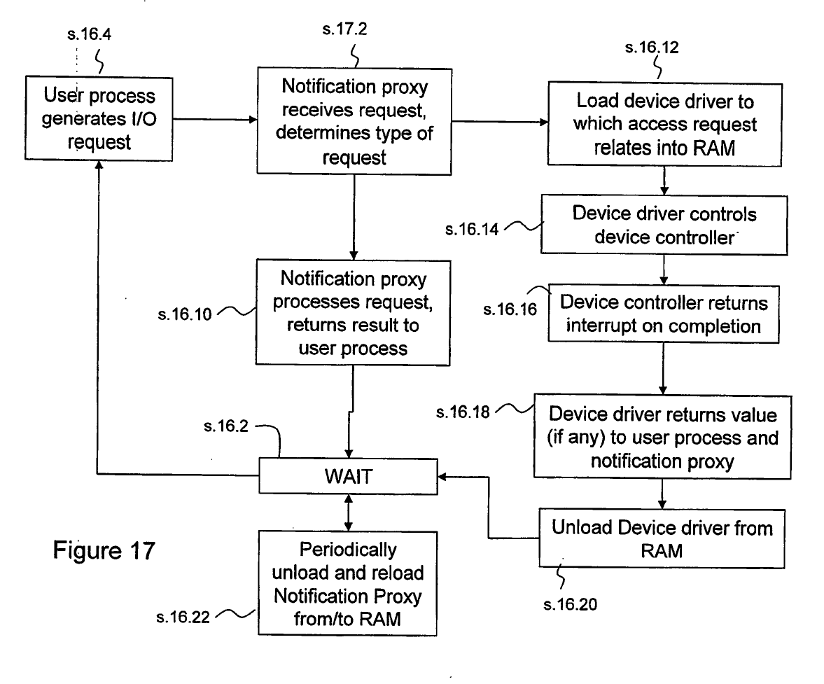

In the particular case where I/O devices are concerned, instead of the operating system deciding whether a user process request should be sent to a notification proxy, or whether the device driver should be loaded, instead, in a further embodiment any user I/O request can automatically be processed by the notification proxy in the first instance. Thus, at FIG. 17 when a user process generates an I/O request at step 16.4, the notification proxy program is run at step 17.2, to determine the type of the request. If the request is a request to access, control, or otherwise use one of the I/O devices, then the appropriate device driver is loaded into RAM at step 16.12, and then steps 16.14 to 16.20 are performed as described previously. In contrast, if the notification proxy determines that the request is a notification request, then it may process the request by sending the required information to the user process.

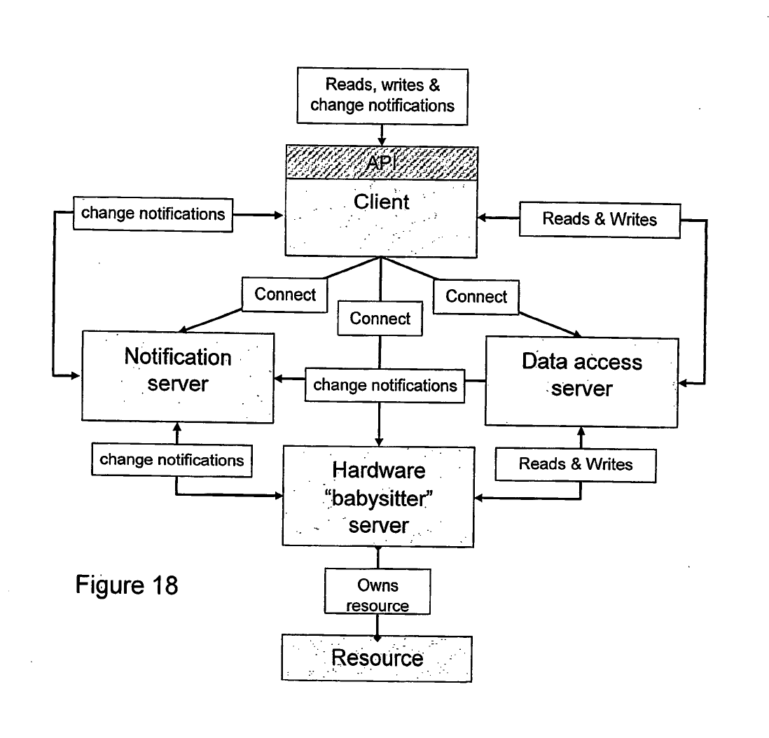

FIG. 18 shows a further embodiment of the invention, based upon the previously described second embodiment of the invention where a connection and notification server handles client connections and notifications in place of the access server, but with some minor modifications. As in the previous embodiments, however, the further embodiment splits a server into 2 servers.

More particularly, as shown in FIG. 18, within the present embodiment one server would be a lightweight “notification” server with no knowledge of the server's functionality, and the other would be a “data access” server containing the bulk of the implementation and the dependencies. The single client side library insulates clients from this split, as discussed previously. As illustrated in FIG. 18, the client side library provides two connection methods for clients; a “Connect for Read/Write” and a “Connect for Notifications”, again as discussed. A further optimisation might be to separate the “Connect for Read” and “Connect for Write” as well, in the case where these two cases could involve significant functional differences and hence decomposition. Clients connecting for notifications are routed to the notification server. Other clients are routed to the data access server. The notification server then keeps track of the status of the clients, by maintaining a client connection list, as described.

In this further embodiment the data access server sends any change notification events to the notification server for distribution to the clients. The result is that when no clients are connected for “data access”, the data access server can close, saving RAM and execution cycles. The notification server stays running, using very little RAM. At such point as data access is needed again, the data access server can reload either via a direct connection from the client side or by a trigger from the notification server.

In the further embodiment shown in FIG. 18, however, where an access server is looking after a hardware resource, a third component may be introduced as a “babysitter” for the hardware resource which is able to bootstrap the main data access server when full functionality is needed. This enables the monitoring of hardware components that need some basic control when they are idle or notionally switched off. When the hardware is in active use, either via the client API or via some external event that causes the hardware to begin operating (eg the connection of a cable) the main data access server can be started up, again transparently to the clients.

Using the above there is no need for any server to have its own notification mechanism, and they could all close when there were no active data access clients connected. Similarly the owners of hardware that is idle or off can also close until the hardware was needed. This would enable a great deal more of the system to be made transient, with potentially significant RAM savings.

Thus, we have described several embodiments of the present invention wherein a system resource handler program, such as a device driver, or access server, is unloaded from memory in dependence on the type of usage requests that are received from other client or user programs of the system resource. In particular, when it is determined that the only usage requests are requests to be informed of any changes of state or one or more other properties of the system resource, then as there are no pending access requests which may cause changes of state or other properties to occur, the resource handler program can be unloaded from main or higher memory. In this way, significant memory savings can be achieved, as well as execution cycles, resulting in improved overall system performance.

Moreover, within this specification we describe the embodiments in the context of a computer system. Within this term we intend to encompass any system having a processor, memory etc. and which is capable of performing computations. Thus, for example, in addition to computer systems such as PCs, laptops, mainframes, distributed systems, and the like, the embodiments of the invention may also find use in devices such as games consoles, PDAs, mobile telephones, and in fact any system which makes use of memory to store processes.

Furthermore, within this specification we refer to usage requests made by processes. By the term “process” we intend to include individual process threads of multi-thread processes. Therefore, the same process having multiple process threads might make different usage requests of the system resource, from different threads of the same multi-thread process.

Various modifications, changes, and/or alterations may be made to the above described embodiments to provide further embodiments which use the underlying inventive concept, falling within the spirit and/or scope of the invention. Any such further embodiments are intended to be encompassed by the appended claims.

1. A computer system having at least one system resource, and provided with at least one system resource administrator program associated with said at least one system resource for administering said resource, the system having a control element which causes said system resource administrator program to be loaded into at least main or higher memory in dependence on the type of usage requests therefor made by other processes, said usage requests being one of a first type relating to requesting notifications of one or more properties of the system resource or a second type relating to requesting administration of said system resource.

2. A computer system according to claim 1, wherein said system resource administrator program is unloaded from said main or higher memory when said usage requests are each of the first type.

3. A computer system according to claim 1 or 2, wherein said system resource administrator program is loaded into main or higher memory when at least a subset of said usage requests are of the second type.

4. A computer system according to claim 1, 2, or 3 wherein said system resource administrator program is further arranged to report changes in any one or more properties of the system resource to which it relates to a notification management program.

5. A computer system according to any of the preceding claims, wherein said notification management program is separately loadable from said system resource administrator program.

6. A computer system having a notification management program which determines whether a request made by another process to use a system resource is of a first type relating to requesting notifications of one or more properties of the system resource, or of a second type relating to requesting administration of said system resource, wherein when said other process request is of the first type, an identifier corresponding to said other process and the request type is stored.

7. A computer system according to claim 6, wherein a system resource administrator program associated with said at least one system resource for administering the resource is loaded or unloaded from main or higher memory in dependence on said stored identifiers.

8. A computer system according to claim 6 or 7, wherein the notification management program is further arranged to receive information relating to changes in a system resource from a system resource administrator program associated therewith; said notification management program being arranged to receive and respond to requests from other processes for notification of one or more properties of the system resource.

9. A computer system according to any of claims 6 to 8, wherein said notification management program operates in respect of a plurality of system resources.

10. A computer system having a system resource request labelling element arranged to receive requests for usage of a system resource, and determine the type of the request as one of a first type relating to requesting notifications of one or more properties of the system resource, or of a second type relating to requesting administration of said system resource, the labelling element being further arranged to label said requests as one of said first or second types.

11. A computer system according to claim 10, wherein said labelled requests are forwarded to a notification management program.

12. A computer system according to any of the preceding claims, wherein said system resources include any one or more of: I/O devices; memory resources; and communications resources.

13. A computer system according to any of claims 4 to 9, and 11, wherein the notification management program is periodically unloaded from main (or higher) memory, and then subsequently reloaded.

14. A computer system according to claim 13, wherein said unload occurs when other processes which might make notification requests are in idle states.

15. A computer system according to any of the preceding claims, wherein said system resource administrator program is a device driver for said system resource.

16. A computer system according to any of the preceding claims, wherein said system has a client-server architecture with routing of messages between a client process and a server process performed by the computer system operating system kernel.

17. A computer system according to any of the preceding claims, wherein said system is a distributed system comprising two or more machines connected for inter-communication there between, the system resource administrator program, notification management program and any requesting processes being distributed across said two or more machines.

18. A method of operating a computer system having at least one system resource, and provided with at least one system resource administrator program associated with said at least one system resource for administering said resource, the method comprising loading said system resource administrator program into at least main or higher memory in dependence on the type of usage requests therefor made by other processes, said usage requests being one of a first type relating to requesting notifications of one or more properties of the system resource or a second type relating to requesting administration of said system resource.

19. A method according to claim 18, wherein said system resource administrator program is unloaded from said main or higher memory when said usage requests are each of the first type.

20. A method according to claim 18 or 19, wherein said system resource administrator program is loaded into main or higher memory when at least a subset of said usage requests are of the second type.

21. A method according to any of claims 17 to 20 wherein said system resource administrator program is further arranged to report changes in any one or more properties of the system resource to which it relates to a notification management program.

22. A method according to claim 21, wherein said notification management program is separately loadable from said system resource administrator program.

23. A method of operating a computer system having a notification management program which determines whether a request made by another process to use a system resource is of a first type relating to requesting notifications of one or more properties of the system resource, or of a second type relating to requesting administration of said system resource, wherein when said other process request is of the first type, an identifier corresponding to said other process and the request type is stored.

24. A method according to claim 23, wherein a system resource administrator program associated with said at least one system resource for administering the resource is loaded or unloaded from main or higher memory in dependence on said stored identifiers.

25. A method according to claims 23 or 24, wherein the notification management program is further arranged to receive information relating to changes in a system resource from a system resource administrator program associated therewith; said notification management program being arranged to receive and respond to requests from other processes for notification of one or more properties of the system resource.

26. A method according to any of claims 23 to 25, wherein said notification management program operates in respect of a plurality of system resources.

27. A method of operating a computer system comprising the steps: receiving requests for usage of a system resource; determining the type of the request as one of a first type relating to requesting notifications of one or more properties of the system resource, or of a second type relating to requesting administration of said system resource; and labelling said requests as one of said first or second types.

28. A method according to claim 27, and further comprising forwarding said labelled requests to a notification management program.

29. A method according to any of claims 18 to 28, wherein said system resources include any one or more of: I/O devices; memory resources; and communications resources.

30. A method according to any of claims 21 to 26, and 28, wherein the notification management program is periodically unloaded from main (or higher) memory, and then subsequently reloaded.

31. A method according to claim 30, wherein said unload occurs when other processes which might make notification requests are in idle states.

32. A method according to any of claims 18 to 31, wherein said system resource administrator program is a device driver for said system resource.

33. A method according to any of claims 18 to 32, wherein said system has a client-server architecture with routing of messages between a client process and a server process performed by the computer system operating system kernel.

34. A method according to any of claims 18 to 33, wherein said system is a distributed system comprising two or more machines connected for inter-communication there between, the system resource administrator program, notification management program and any requesting processes being distributed across said two or more machines.

35. A computer program or suite of computer programs arranged such that when executed by a computer they cause the computer to operate in accordance with the method of any of claims 18 to 34.

36. A computer readable medium storing the computer program, or at least one of the suite of computer programs, according to claim 35.

37. A computer operating system arranged to operate the computer according to the method of any of claims 18 to 34.
